(19) United States
(12) Patent Application Publication
(10) Pub. No.: US 2004/0263628 A1
(43) Pub. Date: Dec. 30, 2004

(54) Image pickup apparatus and information processing method for image pickup apparatus

(75) Inventors: Yasuhito Ambiru, Tokorazawa-shi (JP); Hiroshi Yoshimura, Saitama-shi (JP); Isao Ooshima, Kawasaki-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/812,928

(22) Filed: Mar. 31, 2004

(30) Foreign Application Priority Data
Jun. 27, 2003 (JP) 2003-184972

(51) Int. Cl. H04N 5/225; H04N 5/76

(52) U.S. Cl. 348/207.1; 386/117

(57) ABSTRACT

An image pickup apparatus has an image pickup section which picks up an image and outputs image information, a determining section which makes a determination whether to execute a pixel addition process for the image information in accordance with a result of optical measurement executed from the image information, a pixel addition section which executes the pixel addition process for the image information when the determining section makes a determination for execution of the pixel addition process, and a transmitting section which transmits to the outside the image information to which the pixel addition section has executed pixel addition process. In the event of underexposure, the he image pickup apparatus automatically executes the pixel addition process without requiring a user to make a determination and make an instruction operation each time.

### CROSS-REFERENCE TO RELATED APPLICATIONS

This application is based upon and claims the benefit of priority from prior Japanese Patent Application No. 2003-184972, filed Jun. 27, 2003, the entire contents of which are incorporated herein by reference.

### BACKGROUND OF THE INVENTION

1. Field of the Invention

The present invention relates to image pickup apparatuses, such as network cameras. More specifically, the invention relates to an image pickup apparatus and an information processing method for the image pickup apparatus that perform processes, such as a pixel addition process, for tuning underexposure occurring in a network camera.

2. Description of the Related Art

With wide spread use of digital devices, a wide variety of image information devices, such as digital cameras, are developed and produced. In the case that underexposure images are formed with such digital cameras, it is conceivable to correct the exposure by performing some process.

In this connection, there is an example of a prior art (Jpn. Pat. Appln. KOKAI Publication No. 2000-184274) that executes a pixel addition process for image information to correct the exposure.

However, while the conventional technique is the pixel addition process to be performed with a digital camera, it is not mentioned about a pixel addition process to be performed with, for example, a monitor camera provided via a network. In addition, the pixel addition process in the conventional case is generally performed in accordance with determinations made by a user and instructions provided by the user. However, an operational procedure is unknown for executing the pixel addition process in an image pickup apparatus used as a network camera such as a monitor camera.

### BRIEF SUMMARY OF THE INVENTION

An embodiment of the invention is an image pickup apparatus comprising an image pickup section which picks up an image and outputs image information; a determining section which makes a determination whether to execute a pixel addition process for the image information from the image pickup section in accordance with a result of optical measurement executed from the image information; a pixel addition section which executes the pixel addition process for the image information received from the image pickup section when the determining section makes a determination for execution of the pixel addition process; and a transmitting section which transmits to the outside the image information to which the pixel addition section has executed pixel addition process.

### BRIEF DESCRIPTION OF THE SEVERAL VIEWS OF THE DRAWING

FIG. 1 is a block diagram showing an embodiment of the configuration of an image pickup apparatus according to the present invention;

FIG. 2 is an explanatory view showing an example of a connection method for connection to a network for the image pickup apparatus according to the invention;

FIG. 3 is a cross-sectional view showing the embodiment of the configuration of the image pickup apparatus according to the invention;

FIG. 4 is a flowchart showing an example of a pixel addition process method for the image pickup apparatus according to the invention;

FIG. 5 is a set screen used to set the pixel addition process of the image pickup apparatus according to the invention; and

FIG. 6 is a view showing a display screen in the pixel addition process of the image pickup apparatus according to the invention.

### DETAILED DESCRIPTION OF THE INVENTION

With reference to the drawings, a network camera, serving as an image pickup apparatus according to the invention, will be described in detail hereinbelow.

<Network Camera, Serving as Image Pickup Apparatus of the Invention>

(Configuration)

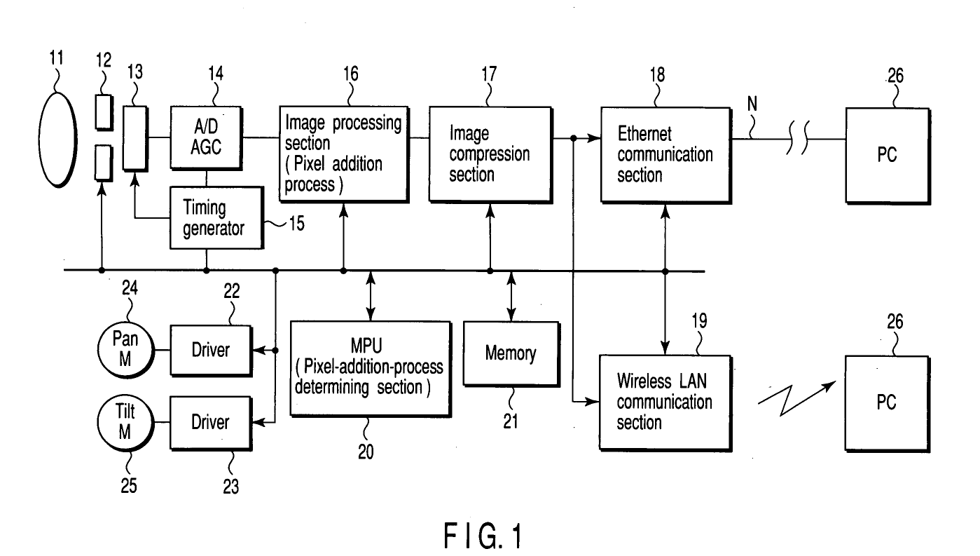

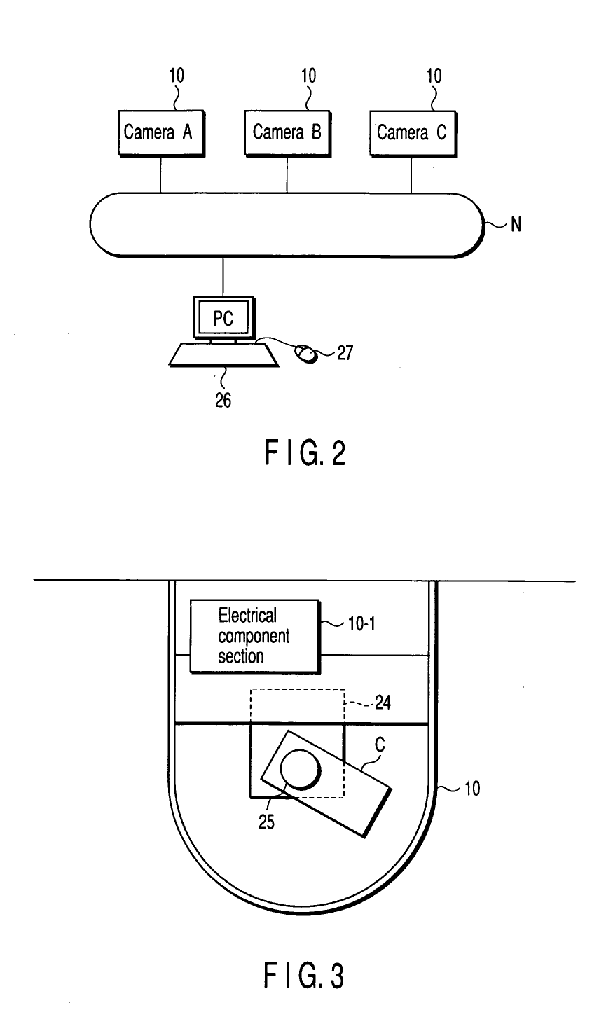

With reference to the drawings, an image pickup system will be described hereinbelow with reference to an example case of a PC (Personal Computer) connected to network cameras and a network. FIG. 1 is a block diagram showing an embodiment of the configuration of an image pickup apparatus according to the invention. FIG. 2 is an explanatory view showing an example of a connection method for connection to a network for the image pickup apparatus according to the invention. FIG. 3 is a cross-sectional view showing the embodiment of the configuration of the image pickup apparatus according to the invention.

As shown in FIG. 1, a network camera apparatus 10 has an objective lens 11, a mechanical iris mechanism 12, and a solid-state image pickup device 13 formed of CCD (charge coupled device) and the like. The iris mechanism 12 receives incident light traveled through the objective lens 11, receives a control signal corresponding to a predetermined exposure value, and performs mechanical exposure correction in accordance with the control signal. The solid-state image pickup device 13 receives the incident light corrected for exposure and outputs a detection signal corresponding to the incident light. Additionally, the solid-state image pickup device 13 receives from a timing generator 15 a control signal for controlling timing of a conversion process that converts the detection signal corresponding to the incident light, thereby performing the conversion process. As such, the exposure correction also can be performed with the timing provided from the control signal. The detection signal from the solid-state image pickup device 13 is supplied to an A/D converter/AGC (Auto Gain Controller) circuit 14 that performs gain control, and is converted thereby to a digital signal. The signal is output by being further converted into an appropriate value in accordance with the control signal received from the timing generator 15.

The network camera apparatus 10 has an image processing section 16 that receives an output from the A/D converter/AGC circuit 14, and an image compressing section 17 that performs a compression process, such as an MPEG compression process or a JPEG compression process or the like, of an image signal subjected to image processes in the image processing section 16. The image processing section 16 executes various processes such as a sharpness process, a contrast process, a gamma correction, white balance process and a pixel addition process or the like for the input image signal.

In addition, the network camera apparatus 10 has an MPU 20 (Main Processing Unit) and a memory 21. The MPU 20 controls the total processing operation, and controls the pixel addition process, which is a feature of the invention described below. In the memory 21, for example, work areas are allocated for execution of the individual processing operations of image signals, and data such as that of alarm images to be recorded in movement detection and the like is stored.

The network camera apparatus 10 is connected to the MPU 20 via a data bus, and has an Ethernet communication section 18, a wireless LAN (Local Area Network) communication section 19. Thereby, the network camera apparatus 10 performs communication processes with, for example, an external PC 26 via a wired network N or a wireless network.

The network camera apparatus 10 further has a pan driver 22 that is connected to the MPU 20 via the data bus and that is controlled thereby to drive a camera unit C in a pan direction; a pan motor 24 formed of a motor of such as a stepping motor or the like; a tilt driver 23 for driving the camera unit C in a tilt direction; and a tilt motor 25 formed of a motor such as a stepping motor or the like. The camera unit has at least the objective lens 11, the mechanical iris mechanism 12, and the solid-state image pickup device 3.

As shown in FIG. 2, a plurality of the network camera apparatuses 10 may be provided via the wired network N. In addition, drive processing of the network camera apparatus 10 can be done in the tilt direction and the pan direction by using the PC 26 or the like. Further, monitoring, record/reproduction processes, and the like can be done for an image signal of an image picked up using the network camera apparatus 10. Moreover, a pointing device 27 such as a mouse or the like is connected to the PC 26.

In addition, as shown in FIG. 3, the network camera apparatus 10 has the camera unit C; the pan motor 24 for driving the camera unit C in the pan direction; the tilt motor 25 for driving the camera unit C in the tilt direction; and further, an electrical component section 10-1 having other configurations shown in FIG. 1.

(Basic Operations)

The network camera apparatus 10 having the configuration described above performs basic operations described hereunder. Specifically, the network camera apparatus 10 is capable of performing operations, such as an image pickup operation in which incident light is received from a subject, and an image signal corresponding to a screen of an image picked up of the subject is supplied via the network and the like; a camera driving operation that drives the camera unit C in, for example, the pan direction or the tilt direction; operations (such as a motion detection operation) in various operation modes in accordance with image signals of picked-up images; and various setting operations that perform settings of an exposure correction method described below; and self-test operations.

More specifically, the image pickup operation is performed under control of the MPU 20 in accordance with an operation program stored in the memory 21 upon receipt of a command signal from, for example, the PC 26 or the like, serving as the control unit via the network N (or the wireless network). Having received incident light from a subject through the objective lens 11, the solid-state image pickup device 13 supplies a detection signal corresponding to the incident light to the A/D converter/AGC circuit 14.

By way of example, the exposure correction is performed according to individual control operations of the mechanical iris mechanism 12, the solid-state image pickup device 13, and the A/D converter/AGC circuit 14. More specifically, upon receipt of an exposure control signal from the MPU 20, the mechanical iris mechanism 12 performs desired exposure correction by controlling input light quantity. With the solid-state image pickup device 13, shutter speed is corrected as an electronic shutter functionality. Similarly to the above, the solid-state image pickup device 13 is supplied with an exposure control signal from the MPU 20 and is then supplied with a timing signal corresponding to the control signal from the timing generator 15. The solid-state image pickup device 13 performs a conversion process of the incident light into a detection signal corresponding to timing of the timing signal, whereby the shutter speed is tuned, and the exposure correction can be implemented.

Similarly, the AGC circuit 14 is supplied with an exposure control signal from the timing generator 15 that has received a control signal from the MPU 20; and in accordance with the control signal, the AGC circuit 14 performs the exposure compensation by controlling the gain of a detection signal supplied from the solid-state image pickup device 13. In this case, while three stages of the exposure correction have been discussed by way of example, the exposure correction can be implemented in any one of the three stages. Further, the correction processing can also be implemented by a pixel addition process or the like of the image processing section 16, for example.

Additionally, in the camera driving operation, the MPU 20 always recognizes the direction of the current camera unit C after zero-coordination tuning in the stepping motors, serving as the pan motor 24 and the tilt motor 25. Thereby, the MPU 20 always controls the coordinates of the screen of images being picked up by the camera unit C. More specifically, when the camera unit C is driven to the pan direction or the tilt direction in accordance with an operation control signal being supplied from the MPU 20 to the driver and when the image-pickup screen is thereby varied, the MPU 20 synchronously enters the mode of always recognizing the coordinates of the current image-pickup screen. As such, on the screen of the PC 26 or the like connected via the network, while viewing an image-pickup screen corresponding to image signals continually being supplied from the current image pickup apparatus 10, the user can move the camera unit C in the pan direction or the tilt direction. Concurrently, the user can view an image-pickup screen an image-pickup screen corresponding to the movement of the camera unit C. In addition, the MPU 20 recognizes and manages the coordinates of the current image-pickup screen; and corresponding to operations, also the user can acquire information of the coordinates of the current image-pickup screen into the PC 26, for example.

In each operation mode, for example, in a movement detection operation mode, the image pickup apparatus 10 automatically detects the movement of an image in an arbitrary area set by the user. More specifically, suppose that, on a set screen in the movement detection operation mode, a movement-detection observation area in an image-pickup screen is set in response to the user operation; and thereafter, in a set period of time, a variation greater than or equal to a predetermined value set for the image-pickup screen is detected in the movement-detection observation area. In this event, the MPU 20 determines that a movement detection exists and performs operations, such as a warning operation to output an alarm signal, and addition of an alarm image stored in the memory 21 to an image signal to output the signal or the like.

(Processing Operations of Correction Processing in Pixel Addition Process)

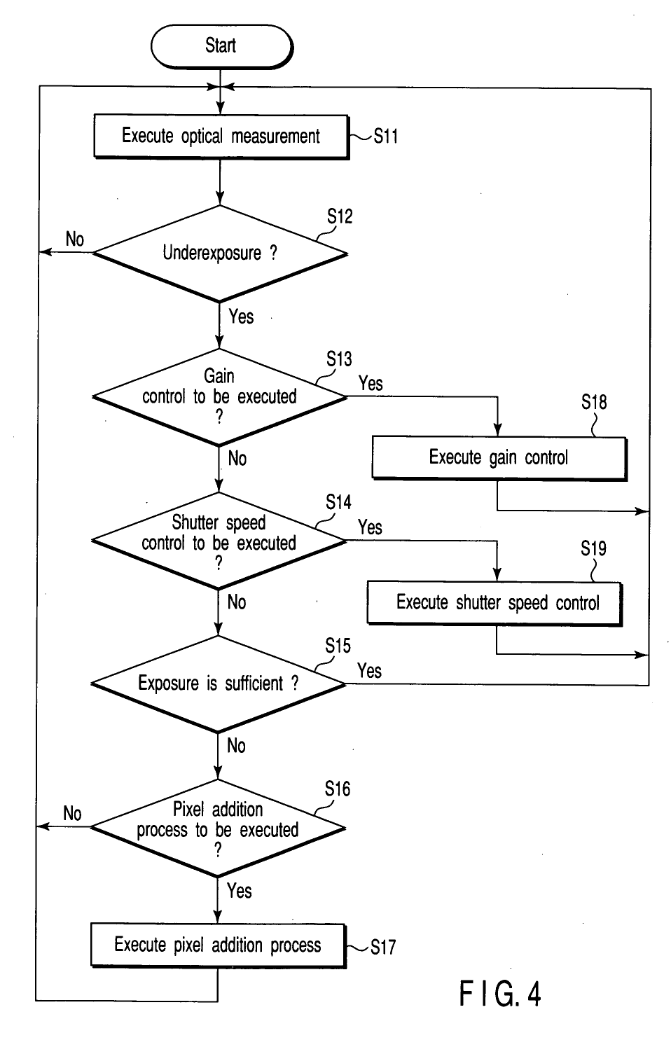

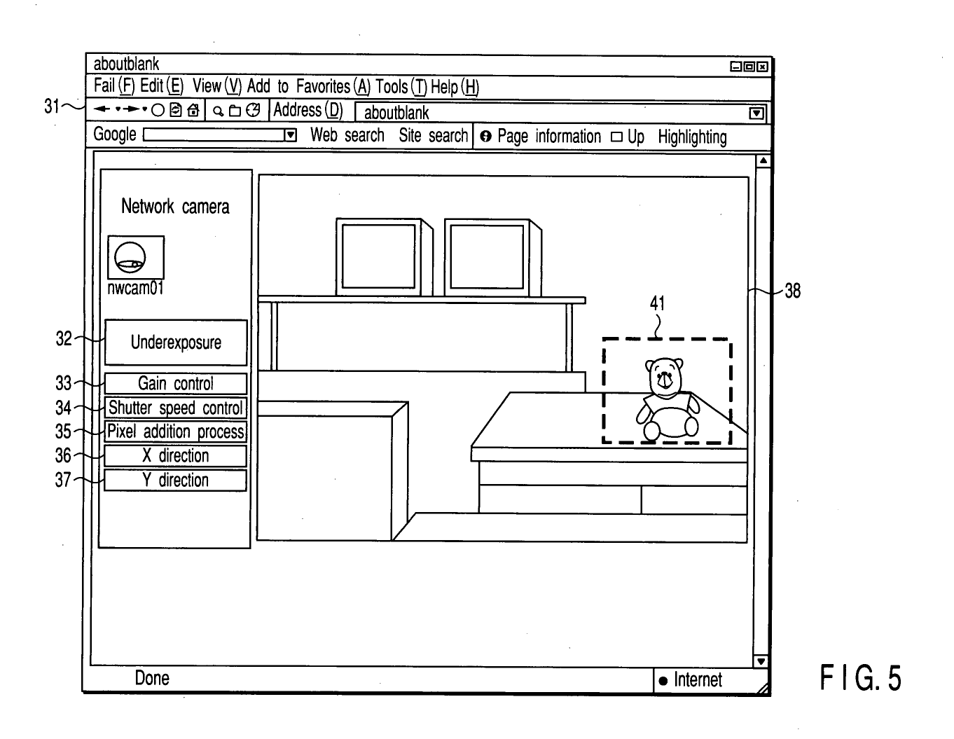

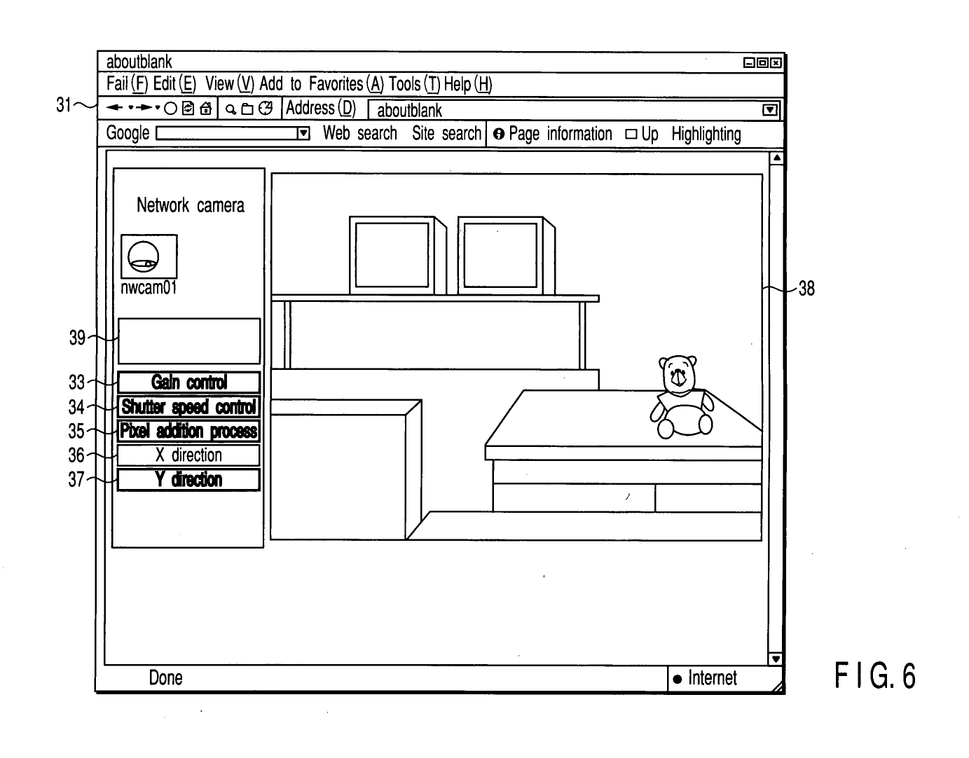

With reference to a flowchart, a description will be made hereinbelow in detail regarding processing operations of the exposure correction to be performed by the pixel addition process of the invention in the image pickup apparatus 10 of the invention that performs the basic operations described above. FIG. 4 is a flowchart showing an example pixel addition processing method. FIG. 5 is an example of a set screen for setting the pixel addition processing. FIG. 6 is a view showing an example of a display screen in the pixel addition processing.

By way of an example, in the processing operation of the exposure correction by the pixel addition process of the invention, when a result of optical measurement of an image pickup section is less than a predetermined value, the pixel addition process is not immediately performed. The pixel addition process is performed when, for example, an underexposure state still remains uncorrected even after gain control and shutter speed control have been performed.

With a CCD of, for example, a megapixel class, being provided, the exposure correction in the pixel addition process of the invention is enabled to output an image of a VGA level size even when a pixel addition is performed. Accordingly, automatic setting of the pixel addition process is enabled, whereby even when a room to be monitored is somewhat dark, a monitoring-target image can be securely picked up and preserved. Further, effective exposure correction can be accomplished not only by the pixel addition process but also by gain control and shutter speed control being appropriately performed therewith.

With reference to the flowchart shown in FIG. 4, the operation of the exposure correction in the pixel addition process of the image pickup apparatus 10 of the invention will be described hereunder. At the outset, an irradiance of a subject is received from the image pickup device 13 (CCD) through the objective lens 11. A detection signal having been output from the image pickup device 13 is converted and amplified by the A/D converter/AGC circuit 14, and the exposure is measured in accordance with the detection signal (S11). In this step, if the detection signal is a predetermined value or less, the operation determines the event to be an underexposure event (S12).

Subsequently, in the event of underexposure, the operation determines whether to perform gain control (S13). The operation hereat determines whether setting of gain control for underexposure has been specified through, for example, a set screen shown in FIG. 5 (described below) or the like (S13). If the setting of the gain control has been specified, the AGC circuit 14 or the like performs the gain control in response to an exposure control signal issued from the MPU 20 (S18). If the underexposure is thereby corrected, the exposure control terminates. However, the underexposure state still remains uncorrected, the operation determines whether setting of shutter speed control for under-exposure has been specified through the set screen shown in FIG. 5 (described below) or the like (S14). If the setting has been specified to execute the shutter speed control, the operation executes the exposure correction by converting a detection signal and thereby tuning the shutter speed (S19). In this case, a case can take place in which the two executions of the exposure control are omitted. In addition, the executions of the exposure control may be preferably executed by an alternative process.

Further, if the underexposure state still remains uncorrected even after the executions of the exposure control (S15), the operation verifies that the setting in which in case of underexposure, a pixel addition process is performed is specified on the set screen of FIG. 5 or the like (S16). The operation then executes a pixel addition process for image information that has been detected (S17).

The pixel addition process for the image information is performed in such a manner that, for example, two pixels are added together to be one pixel for the X direction of the image information. In this case, the number of pixels is reduced to ½. Alternatively, it is possible that two pixels be added together to be one pixel for the Y direction of the image information. In this case also, the number of pixels is reduced to ½. Still alternatively, it is preferable that two pixels be added together to be one pixel individually for the X direction and the Y direction. In this case, the number of pixels is reduced to ¼. Of course, four pixels can be added together to be one pixel in one direction, in which the number of pixels is reduced to ¼. The user is allowed to arbitrarily select the combination of these adding modes.

(Setting Operations for Exposure Correction in Pixel Addition Process)

FIG. 5 shows an example of a set screen for the exposure correction in the pixel addition process. The set screen used to select processings for the exposure correction may be of any type. A preferable type is, however, such as that the user is allowed to invoke the set screen for specification in the operation screen of the PC 26 connected to the network shown in FIG. 2.

Another example of a preferable set screen is of the type to be used with a browser application (not necessary be a browser application, though) displayed by the PC 26 connected to the network, as shown in FIG. 2. In this case, for example, on a view screen 31 through which a screen of an image picked up by the image pickup section is viewable, when, for example, the MPU 20 has detected an underexposure event, set icons 33 to 37 are displayed on the screen with the display “Underexposure” 32.

More specifically, the user can specify settings for the exposure correction by operating the pointing device such as, for example, the mouth 27 and arbitrarily selecting individual icons. The icons are named as a gain control 33, a shutter speed control 34, a pixel addition process 35, a pixel addition process 36 for the X direction, and a pixel addition process 37 for the Y direction. Settings specified on the screen are used as setting information and are incorporated into the operation shown in the flowchart of FIG. 4.

A current screen is displayed in a display screen shown in FIG. 6. The invention is well suited to displaying the current status of the exposure correction processing for underexposure on that display screen. More specifically, a view screen 31 displays that an icon 39 is displayed to indicate that the exposure correction for compensating for the exposure is in progress. Concurrently, icons are appropriately displayed active to thereby inform to the user that the current exposure correction is in progress with the gain control 33, the shutter speed control 34, and the pixel addition process 35. In addition, the screen informs the user that the current pixel addition process is being performed for the Y direction of the image information.

(Specification of Exposure Measurement Range)

In addition to the above, the present invention is well suited to arbitrarily specifying an exposure measurement range in the exposure correction in the pixel addition process. More specifically, in the view screen 31 shown in FIG. 5, an exposure measurement range 41 can be arbitrarily specified by operating a device such as, for example, the pointing device 27 or the like. In response, the MPU 20 operates so that the exposure measurement range 41 is set into the memory 21 or the like, and thereafter, the exposure measurement range 41 is assumed as the measurement range in the operation shown in the flowchart of FIG. 4 (S11). This enables at least the exposure measurement range 41 to securely be monitored.

Meanwhile, the exposure measurement range is preferably specified on a screen of a browser application with the PC 26 connected to the network. However, the manner of the specification is not limited thereto. In addition, the specification of the exposure measurement range is not limited to be made inside of the screen of an image being currently picked up by the image pickup section. However, the specification can be made in an image pickup enable range where an image has been capable of being picked up according to a range where the pan motor 24 and the tilt motor 25 that are shown in FIG. 1 are runnable. Accordingly, regardless of the level of brightness/darkness in a room, a target required to securely be monitored can securely be monitored in the image pickup enable range.

The PC 26 described as the control unit in the network is simply an example, and it may be replaced with a digital image recorder having equivalent functionality. Thereby, as in the case of the PC 26, not only the image pickup operation, a picked-up image can be recorded and reproduced.

According to the various embodiments and/or examples described above, those skilled in the art will be able to implement the invention, and various other modified examples will easily occur to those skilled in the art. Further, it will be possible even for those not having sufficient inventive abilities to adapt the invention by way of various other embodiments. Thus, the invention covers a broad range of applications as long as they do not contradict the principles and novel features disclosed herein; that is, the invention is not limited to the embodiments and/or examples described hereinabove.

As described above, according to the present invention, the image pickup apparatus can be provided that automatically detects underexposure of a picked-up image and that performs the appropriate exposure correction process including the pixel addition process without awaiting instructions of a user for the correction each time. Consequently, as the network monitor camera, the image pickup apparatus is capable of implementing automatic secure monitoring of a target.

What is claimed is:

1. An image pickup apparatus comprising:
an image pickup section which picks up an image and outputs image information;
a determining section which makes a determination whether to execute a pixel addition process for the image information from the image pickup section in accordance with a result of optical measurement executed from the image information;
a pixel addition section which executes the pixel addition process for the image information received from the image pickup section when the determining section makes a determination for execution of the pixel addition process; and
a transmitting section which transmits to the outside the image information to which the pixel addition section has executed pixel addition process.

2. An image pickup apparatus according to claim 1, wherein the determining section automatically makes the determination without receiving an instructing operation each time from a user.

3. An image pickup apparatus according to claim 1, wherein the determining section makes a determination in accordance with the result of the optical measurement executed from the image information whether to execute gain control of the image information received from the image pickup section and further makes a determination whether to execute the pixel addition process for the image information after execution of the gain control.

4. An image pickup apparatus according to claim 1, wherein the determining section makes a determination in accordance with the result of the optical measurement executed from the image information whether to execute shutter speed control of the image pickup section and further makes a determination whether to execute the pixel addition process for the image information after execution of the shutter speed control.

5. An image pickup apparatus according to claim 1, wherein the pixel addition process performs an addition of the image information regarding at least one an X direction of the image information and a Y direction thereof.

6. An image pickup apparatus according to claim 1, wherein the pixel addition process performs an addition of the image information regarding both an X direction of the image information and a Y direction thereof.

7. An image pickup apparatus according to claim 1, further comprising an image processing section which generates a signal for a set screen which prompts setting of a remedial method for tuning a light-quantity shortage of the image information and which is displayed in a browser application displayed in an external device connected via the transmitting section.

8. An image pickup apparatus according to claim 1, further comprising an image processing section which generates a signal for a set screen which prompts selection of at least one of gain control, shutter speed control, and the pixel addition process to tune a light quantity of the image information and which is displayed in a browser application displayed in an external device connected via the transmitting section.

9. An image pickup apparatus according to claim 1, further comprising an image processing section which generates a signal for a set screen which is used to set the level of the pixel addition process of the image information and which is displayed in a browser application displayed in an external device connected via the transmitting section.

10. An image pickup apparatus according to claim 1, further comprising an image processing section which generates a signal for displaying the type of a current process being executed to tune a light quantity of the image information, the type being displayed in a browser application displayed in an external device connected via the transmitting section.

11. An information processing method for an image pickup apparatus, the method comprising:
picking up an image and outputting image information;
making a determination whether to execute a pixel addition process for the image information in accordance with a result of optical measurement executed from the image information;
executing the pixel addition process for the image information when the determining section makes a determination for execution of the pixel addition process; and
transmitting to the outside the image information to which the pixel addition section has executed pixel addition process.

12. An information processing method for an image pickup apparatus according to claim 11, wherein the determination is automatically made without receiving an instructing operation each time from a user.

13. An information processing method according to claim 11, wherein the determination is made in accordance with the result of the optical measurement executed from the image information whether to execute gain control of the image information and a determination is further made whether to execute the pixel addition process for the image information after execution of the gain control.

14. An information processing method according to claim 11, wherein the determination is made in accordance with the result of the optical measurement executed from the image information whether to execute shutter speed control and a determination is further made whether to execute the pixel addition process for the image information after execution of the shutter speed control.

15. An information processing method according to claim 11, wherein the pixel addition process performs an addition of the image information regarding at least one of an X direction of the image information and a Y direction thereof.

16. An information processing method according to claim 11, wherein the pixel addition process performs an addition of the image information regarding both of an X direction of the image information and a Y direction thereof.

17. An information processing method according to claim 11, wherein a signal for a set screen which prompts setting of a remedial method for tuning a light-quantity shortage of the image information and which is displayed in a browser application displayed in an external device connected via the transmitting section of the image pickup apparatus, is generated

18. An information processing method according to claim 11, wherein a signal for a set screen which prompts selection of at least one of gain control, shutter speed control, and the pixel addition process to tune a light quantity of the image information and which is displayed in a browser application displayed in an external device connected via the transmitting section of the image pickup apparatus, is generated.

19. An information processing method according to-claim 11, wherein a signal for a set screen which is used to set the level of the pixel addition process of the image information and which is displayed in a browser application displayed in an external device connected via the transmitting section of the image pickup apparatus, is generated.

20. An information processing method according to claim 11, wherein a signal for displaying the type of a current process being executed to tune a light quantity of the image information, the type being displayed in a browser application displayed in an external device connected via the transmitting section of the image pickup apparatus, is generated.
